(19) United States
(12) Patent Application Publication
(10) Pub. No.: US 2005/0054344 A1
(43) Pub. Date: Mar. 10, 2005

(54) MBMS method and apparatus for UMTS network

(75) Inventors: Myung Cheul Jung, Seoul (KR); Min Jung Kim, KyoungKi-do (KR); Young Woo Shin, KyoungKi-do (KR); Seung June Yi, Seoul (KR); Young Dae Lee, KyoungKi-do (KR); Sung Duck Chun, KyoungKi-do (KR); So Young Lee, KyoungKi-do (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 90017-5554, US

(73) Assignee: LG Electronics Inc.

(21) Appl. No.: 10/923,341

(22) Filed: Aug. 19, 2004

(30) Foreign Application Priority Data
Aug. 22, 2003 (KR) 10-2003-58429

(51) Int. Cl. H04Q 7/20

(52) U.S. Cl. 455/432.3; 455/414.1; 455/466

(57) ABSTRACT

A method and apparatus for providing a point-to-multipoint service to a mobile terminal that moves from an area controlled by a first radio network controller (RNC) to an area controlled by a second radio network controller is provided. Information regarding a transmission mode status of the second RNC is utilized by the first RNC to determine if it is necessary to transmit MBMS data to the second RNC. MBMS data is transmitted from the first RNC to the second RNC only if the transmission status of the second RNC is point-to-point, thereby preventing unnecessary data transmission between the first RNC and second RNC and the enhancing the efficiency of the radio resources between the second RNC and the mobile terminal.

### CROSS-REFERENCE TO RELATED APPLICATIONS

This application claims the benefit of Korean Application No. 10-2003-0058429 filed on Aug. 22, 2003, which is hereby incorporated by reference.

### BACKGROUND OF THE INVENTION

1. Field of the Invention

The present invention relates to a method and apparatus for providing a multimedia point-to-multipoint service in a universal mobile telecommunications system (UMTS), and more particularly, to a method and apparatus for providing a multimedia point-to-multipoint service to a mobile terminal that moves from an area controlled by one radio network controller (RNC) to an area controlled by another radio network controller. The method and apparatus provides for the efficient management of network and radio resources by transferring radio bearer information between the RNCs.

2. Discussion of the Related Art

FIG. 1 illustrates the general structure of a UMTS network 1. In the UMTS network 1, a mobile terminal 2, or user equipment (UE), is connected to a core network 4 via a UMTS terrestrial radio access network (UTRAN) 6. The UTRAN 6 comprises at least two radio network subsystems 8 each of which has one radio network controller (RNC) 10 and at least one Node B 12 controlled by the corresponding RNC. A Node B 12 is the access point between the UE 2 and the UTRAN 8 for receiving uplink information transferred from a physical layer of the UE 2 and transmitting downlink data to the UE. Each RNC 10 is responsible for allocation and management of radio resources and is an access point between the UE 2 and the core network 4.

Whenever a specific UE 2 is active in the UMTS network 1, there is one RNC 10 acting as its serving RNC such that it is the access point to the core network 4 for data transmission of the UE 2. Any other RNC 10 may act as a drift RNC. A connection between one UE 2 and the UTRAN 6 may be achieved by the serving RNC 10 alone without a drift RNC or may additionally require one or more drift RNCs. In either case, the RNC 10 connected to a Node B 12 via an lub interface controls the radio resources of the Node B and is the controlling RNC, thereby creating a point-to-multipoint relationship between the controlling RNC and the corresponding Node Bs. The controlling RNC 10 controls traffic load and congestion within the corresponding cells and controls code acceptance and code allocation for new radio links.

Information may be transferred between the UE 2 and core network 4 via the UTRAN 6 at any point in time. Generally, this transfer of information occurs via one RNC 10, for example the serving RNC.

Since the UE 2 is mobile, there are times when the UE moves to the area (cell) of a Node B 12 controlled by another RNC 10. When this happens, the function of a drift RNC 10 is necessary, whereby the UE 2 is connected to the serving RNC 10 through the drift RNC.

FIG. 2A illustrates a portion of the UMTS network 1 of FIG. 1 when a conventional connection is made between a UE 2 and the core network 4 via the serving RNC (R1) 10 alone. FIG. 2B illustrates a conventional connection between a UE 2 and the core network 4 via a drift RNC (R2) 10 connected to the serving RNC (R1). It should be noted that the initial connection between the UE 2 and the core network 4 is via the serving RNC (R1) 10, as illustrated in FIG. 2A.

Referring to FIG. 2B, when the UE 2 has moved to a cell controlled by the drift RNC (R2) 10, the RRC connection is established through the drift RNC (R2), which is connected to the serving RNC (R1) via the lur interface. The serving RNC (R1) 10 still controls the UE 2 and acts as the access point to higher layers; the drift RNC (R2) simply performs a function of routing user data or allocating codes as common resources. The serving and drift RNCs 10 are distinguished by the logic related to a specific UE 2 and a specific Node B 12 connection state.

The serving RNC (R1) 10 controls data input via a radio interface or data transmitted to the UE 2 and allocates radio resources appropriate for providing services. Radio resource management functions are control functions related to the specific UE 2 and include transmission channel establishment, handover decisions and open loop power control.

A radio resource control (RRC) layer is defined on a third layer of radio interface protocol for each RNC 10 and UE 2. The RRC layer is responsible for controlling transport and physical channels in association with establishment, reconfiguration, and release of a radio bearer (a service provided by a second layer of radio protocol) established to transfer data between the UE 2 and core network 4. The establishment of a radio bearer defines the behavior of a protocol layer, for example the channel characteristics needed to provide a specific service, and is a process of setting up an operational method of the service and its parameters.

When an RRC layer of a specific UE 2 and an RRC layer of an RNC 10 are connected for the exchange of RRC messages, the corresponding UE is said to be in an RRC-connected state. In the absence of such a connection, the UE 2 is in an RRC idle mode. The serving RNC (R1) 10 of a UE 2 is determined when an RRC connection to an RNC is established.

The RNC 10 recognizes and controls the corresponding UE 2 according to cell units. An RNC 10 is unable to recognize the presence of UEs 2 in the RRC idle mode. The core network 4 (MSC or SGSN) controls UEs 2 in the RRC idle mode according to their location or routing area (an area greater than one cell). While a UE 2 in the idle mode can receive point-to-multipoint service data, for example multimedia broadcast/multicast service (MBMS) data, the UE must be in the RRC-connected state to receive general mobile communication services, which include voice and packet data.

A multimedia broadcast/multicast service (MBMS) provides streaming or background service to a plurality of UEs 2 using downlink-dedicated MBMS bearer services. In the UTRAN 6, an MBMS bearer utilizes point-to-point (p-t-p) or point-to-multipoint (p-t-m) radio bearer services.

As the name implies, an MBMS may be performed in a broadcast mode or a multicast mode. In the broadcast mode, multimedia data is transmitted to all users within a service area, for example the domain where the broadcast service is available. In the multicast mode, multimedia data is transmitted to a specific user group within a service area, for example the domain where the multicast service is available.

A conventional multicast mode transmission is illustrated in FIG. 3, which shows the concurrent events of a specific UE 2 and a specific MBMS. Referring to FIG. 3, a UE 2 to be provided with an MBMS first completes a subscription procedure to establish a relationship between the UE and the provider of the MBMS. All subscribing UEs 2 should receive a start service announcement provided by the network which corresponds to the specific MBMS and informs subscribing UEs of a list of services to be provided and associated information.

To participate in the specific group of UEs 2 receiving a specific MBMS, a UE “joins” a multicast group. Joining a multicast group includes notifying the UMTS network 1 of the intention to receive the specific MBMS. To terminate participation in a group, a UE 2 performs a “leave” operation. Subscription, joining, and leaving are performed by each UE 2 for each service and may be carried out at any time prior to, during, or after the data transfer.

While the specific MBMS is in progress, for example at some time after transmission of the start service announcement but before a stop service announcement, one or more sessions of the service may sequentially take place. A session corresponds to a period of data transfer. When an MBMS data source has MBMS data ready for transfer, the core network 4 informs the RNC 10 of a session start. When it is determined that there will be no data transmission available for an extended period of time, for example a long idle period, the core network 4 informs the RNC 10 of a session stop. Data transfer for the specific MBMS can be performed only for the time between the session start and the session stop. In doing so, only UEs 2 having joined the multicast group for the specific MBMS are enabled to receive the MBMS data.

In the session start process, the RNC 10 having received the session start from the core network 4 transmits, at least once before MBMS data transmission, an MBMS notification to participating (joined) UEs 2, thereby informing the UEs that the data transfer of a specific MBMS in a prescribed cell is imminent. At the time of a session start, the RNC 10 recognizes and counts the joined UEs 2 within a specific cell.

As a result of the counting process, the RNC 10 determines, according to a set threshold value, whether to establish a point-to-point or point-to-multipoint radio bearer. The RNC 10 establishes a point-to-point MBMS radio bearer if the number of counted UEs 2 is below the threshold and establishes a point-to-multipoint MBMS radio bearer if the counted number exceeds the threshold.

Once the MBMS radio bearer is determined, the RNC 10 informs the UEs 2 accordingly. If the count warrants a point-to-point radio bearer, all the joined UEs 2 for a specific service are requested to transition to the RRC-connected state to receive MBMS data. On the other hand, such a transition is unnecessary if a point-to-multipoint radio bearer is established since reception with a point-to-multipoint radio bearer is enabled even for UEs 2 in the RRC idle mode. If the counting process determines that there is no UE 2 wishing to receive the service, no radio bearer is established and no MBMS data is transmitted in order to avoid the unnecessary consumption of radio resources.

When the MBMS data for one session of the specific MBMS is received from the core network 4, the RNC 10 transmits the data using the established radio bearer. Upon receiving the session stop, the RNC 10 releases the established radio bearer. A new radio bearer must be established for each subsequent session. If there is no further session scheduled, the stop service announcement is transmitted.

The protocol of the above process of MBMS transmission is executed between the UE 2 and the core network 4 (as well as higher layers) for each service via the controlling RNC 10. If the UE 2 remains in a cell controlled by the RNC 10 at the time of RRC-connection, the protocol is executed based on the configuration of FIG. 2A, for example using the serving RNC (R1) only. If a drift RNC (R2) 10 is necessary, the protocol is executed based on the configuration of FIG. 2B and the UE 2 is connected to the higher layers via at least one drift RNC (R2) and the serving RNC (R1).

An RNC 10 providing an MBMS recognizes and controls a UE2 in the RRC-connected mode among UEs joining a specific MBMS in each cell. The RNC 10 composes a list of UEs 2 in the RRC-connected mode for each MBMS in each cell, the list identifying each UE by its radio network temporary identifier (RNTI). Since the number of joined UEs 2 for a given controlling RNC 10 is likely to increase during the MBMS transmission, an MBMS attach process is performed for each cell.

FIG. 4, illustrates a conventional MBMS attach process when an RRC-connected mobile terminal 2 moves from a cell of a serving RNC (R1) 10 to a cell of a drift RNC (R2). The serving RNC (R1) 10 transmits an MBMS attach request message to the drift RNC (R2), the MBMS attach message including identifiers for the old cell, the specific MBMS, and the mobile terminal 2.

If a radio resource for maintaining the RRC-connected mode of the mobile terminal 2 can be allocated, the drift RNC (R2) 10 accepts the request by attaching the RNTI of the mobile terminal for inclusion in its list of RRC-connected mobile terminals. Subsequently, the drift RNC (R2) 10 transmits an affirmative response to the serving RNC (R1) via an MBMS attach response message. The serving RNC (R1) 10 then transmits the MBMS data to the mobile terminal 2 using a point-to-point radio bearer via the drift RNC (R2). If no radio resource is available, the drift RNC (R2) 10 rejects the request and transmits a negative response to the serving RNC (R1).

As illustrated in FIG. 4, the drift RNC (R2) 10 transmits an affirmative or negative response to the serving RNC (R1) for a specific mobile terminal 2 according to whether the RRC-connected mode of the mobile terminal can be maintained. In the case of an affirmative response, the serving RNC (R1) 10 continues to transmit the MBMS data to the mobile terminal 2 using a point-to-point radio bearer.

If the MBMS data is being transmitted from the drift RNC (R2) 10 using a point-to-multipoint radio bearer, however, the mobile terminal 2 is still provided with the MBMS data via a point-to-point radio bearer of the serving RNC (R1) 10 despite the availability of the MBMS data via the point-to-multipoint radio bearer of the drift RNC (R2). A dedicated resource of a point-to-point radio bearer is needlessly utilized, thereby increasing the data flow between the serving RNC (R1) 10 and the drift RNC (R2) and reducing the efficiency of the radio resources between the drift RNC (R2) and the mobile terminal 2.

Therefore, there is a need for a method and apparatus for providing a point-to-multipoint service to a mobile terminal via an available point-to-multipoint radio bearer when the mobile terminal moves from a cell controlled by a serving RNC to a cell controlled by a drift RNC. The present invention meets these and other needs.

### SUMMARY OF THE INVENTION

The present invention is directed to a method and apparatus for providing a point-to-multipoint service to a mobile terminal that moves from an area controlled by one network controller, for example a serving RNC, to an area controlled by another network controller, for example a drift RNC. Specifically, the invention is directed to a method and apparatus that facilitates transferring information from a drift RNC to a serving RNC to indicate whether a point-to-point or point-to-multipoint radio bearer is provided for the service by the drift RNC such that the serving RNC does not provide the point-to-multipoint service data to the drift RNC if the drift RNC provides the service via a point-to-multipoint radio bearer.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the present invention is embodied in a method and apparatus that provides information to a first network controller regarding a communication mode supported by a second network controller for a specific point-to-multipoint service to be provided to a mobile terminal and facilitates the determination by the first network controller regarding whether the point-to-multipoint service data is provided to second network controller via a point-to-point radio bearer or provided directly by a core network. Specifically, a serving RNC provides an attach request message for a specific point-to-multipoint service to a drift RNC when a mobile terminal moves from an area controlled by the serving RNC to an area controlled by the drift RNC, the drift RNC provides an attach response message to the serving RNC including information regarding a communication mode supported for the specific point-to-multipoint service and the serving RNC determines whether to provide point-to-multipoint service data to the drift RNC.

In one aspect of the invention, a method is provided for providing a point-to-multipoint service to a mobile terminal. The method includes receiving, from a second network controller when the mobile terminal moves from a first cell controlled by a first network controller to a second cell controlled by the second network controller, information indicating whether a point-to-point or point-to-multipoint communication mode is supported by the second network controller and determining, based on the information, whether or not to transmit data associated with the point-to-multipoint service from the first network controller to the second network controller.

It is contemplated that the point-to-multipoint service may be a multimedia broadcast/multicast service (MBMS). It is further contemplated that the information indicating whether a point-to-point or point-to-multipoint communication mode is supported by the second network controller may be received in a point-to-multipoint service attach response message.

Preferably, the point-to-multipoint service data is not transmitted to the second network controller by the first network controller when the second network controller supports a point-to-multipoint communication mode and the point-to-multipoint service data is transmitted to the second network controller by the first network controller when the second network controller supports a point-to-point communication mode. Preferably, the first network controller is a serving network controller and the second network controller is a drift network controller.

In another aspect of the invention, a method is provided for providing a point-to-multipoint service to a mobile terminal. The method includes transmitting, to a first network controller when the mobile terminal moves from a first cell controlled by the first network controller to a second cell controlled by a second network controller, information indicating whether a point-to-point or point-to-multipoint communication mode is supported by the second network controller, receiving point-to-multipoint service data from a core network either directly via the second network controller or via the first network controller and the second network controller, and transmitting the point-to-multipoint service data to the mobile terminal.

It is contemplated that the point-to-multipoint service may be a multimedia broadcast/multicast service (MBMS). It is further contemplated that the information indicating whether a point-to-point or point-to-multipoint communication mode is supported by the second network controller may be included in a point-to-multipoint service attach response message that is transmitted in response to a point-to-multipoint service attach request message.

Preferably, the point-to-multipoint service data is received from the core network directly via the second network controller when a point-to-multipoint communication mode is supported by the second network controller and the point-to-multipoint service data is received from the core network via the first network controller and the second network controller when a point-to-point communication mode is supported by the second network controller. Preferably, the first network controller is a serving network controller and the second network controller is a drift network controller.

In another aspect of the invention, a method is provided for providing a point-to-multipoint service to a mobile terminal. The method includes transmitting a point-to-multipoint attach request message from a first network controller to a second network controller when the mobile terminal moves from a first cell controlled by the first network controller to a second cell controlled by the second network controller, transmitting information indicating whether a point-to-point or point-to-multipoint communication mode is supported by the second network controller from the second network controller to the first network controller, receiving point-to-multipoint service data in the second network controller from a core network either directly via the second network controller or via the first network controller and the second network controller, and transmitting the point-to-multipoint service data from the second network controller to the mobile terminal.

It is contemplated that the point-to-multipoint service may be a multimedia broadcast/multicast service (MBMS). It is further contemplated that the information indicating whether a point-to-point or point-to-multipoint communication mode is supported by the second network controller may be included in a point-to-multipoint service attach response message.

Preferably, the point-to-multipoint service data is received in the second network controller from the core network directly via the second network controller when a point-to-multipoint communication mode is supported by the second network controller and the point-to-multipoint service data is received in the second network controller from the core network via the first network controller and the second network controller when a point-to-point communication mode is supported by the second network controller. Preferably, the first network controller is a serving network controller and the second network controller is a drift network controller.

In another aspect of the invention, a radio network subsystem is provided for providing a point-to-multipoint service to a mobile terminal. The radio network subsystem includes a transmitter, a receiver, a storage unit and a controller.

The transmitter transmits point-to-multipoint service data to the mobile terminal and a second radio network subsystem. The receiver receives information indicating one of a point-to-point and point-to-multipoint communication mode supported by the second radio network subsystem. The storage unit stores information related to the communication mode supported by the second radio network subsystem. The controller performs the methods of the present invention to control the mobile terminal within a designated area and to process the information received from the second radio network subsystem in order to determine whether to transmit point-to-multipoint service data associated with the point-to-multipoint service to the second radio network subsystem when the mobile terminal moves from the designated area to an area controlled by the second radio network subsystem.

It is contemplated that the point-to-multipoint service may be a multimedia broadcast/multicast service (MBMS). It is further contemplated that the receiver may be adapted to receive a point-to-multipoint service attach response message including the information indicating whether a point-to-point or point-to-multipoint communication mode is supported by the second radio network subsystem.

Preferably, the controller is adapted to not transmit the point-to-multipoint service data to the second radio network subsystem when the second radio network subsystem supports a point-to-multipoint communication mode and to transmit the point-to-multipoint service data to the second radio network subsystem when the second radio network subsystem supports a point-to-point communication mode. Preferably, the controller is a serving network controller and the second radio network subsystem includes a drift network controller.

In another aspect of the invention, a radio network subsystem is provided for providing a point-to-multipoint service to a mobile terminal. The radio network subsystem includes a transmitter, a receiver, a storage unit, and a controller.

The transmitter transmits point-to-multipoint service data to the mobile terminal and information indicating one of a point-to-point and point-to-multipoint communication mode supported by the radio network subsystem to a second radio network subsystem. The receiver receives point-to-multipoint service data either directly from a core network or from the core network via the second radio network subsystem. The storage unit stores information related to the communication mode supported by the radio network subsystem. The controller performs the methods of the present invention to control the mobile terminal within a designated area and to provide information indicating either a point-to-point or point-to-multipoint communication mode supported when the mobile terminal moves from an area controlled by the second radio network subsystem to the designated area.

It is contemplated that the point-to-multipoint service may be a multimedia broadcast/multicast service (MBMS). It is further contemplated that the receiver may be adapted to receive a point-to-multipoint service attach request message from the second radio network subsystem and the controller may be adapted to provide the information indicating whether a point-to-point or point-to-multipoint communication mode is supported in response to the point-to-multipoint service attach request message. Moreover, it is contemplated that transmitter may be adapted to transmit a point-to-multipoint service attach response message to the second radio network subsystem and the controller may be adapted to provide the information in the point-to-multipoint service attach response message.

Preferably, the point-to-multipoint service data is received directly from the core network when a point-to-multipoint communication mode is supported and the point-to-multipoint service data is received from the core network via the second radio network subsystem when a point-to-point communication mode is supported. Preferably, the controller is a drift network controller and the second radio network subsystem includes a drift network controller.

It is to be understood that both the foregoing explanation and the following detailed description of the present invention are exemplary and illustrative and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a block diagram of the general structure of a UMTS network.

FIG. 2A illustrates a portion of the UMTS network of FIG. 1 showing a conventional connection of a UE to the UTRAN via a serving RNC alone.

FIG. 2B illustrates a portion of the UMTS network of FIG. 1 showing a conventional connection of a UE to the UTRAN via a drift RNC and a serving RNC.

FIG. 3 illustrates a diagram of a conventional MBMS transmission in a multicast mode showing one session of a specific MBMS transmitted to one UE.

FIG. 4 illustrates a diagram of a conventional MBMS attach process.

FIG. 5 illustrates a flowchart of a drift RNC method according to one embodiment of the present invention.

FIG. 6 illustrates a flowchart of a serving RNC method according to one embodiment of the present invention.

FIG. 7 illustrates a diagram of a point-to-point service transmission according to one embodiment of the present invention.

FIG. 8 illustrates a diagram of a point-to-multipoint service transmission according to one embodiment of the present invention.

FIG. 9 illustrates a UTRAN for providing a point-to-multipoint service to a mobile terminal according to one embodiment of the present invention.

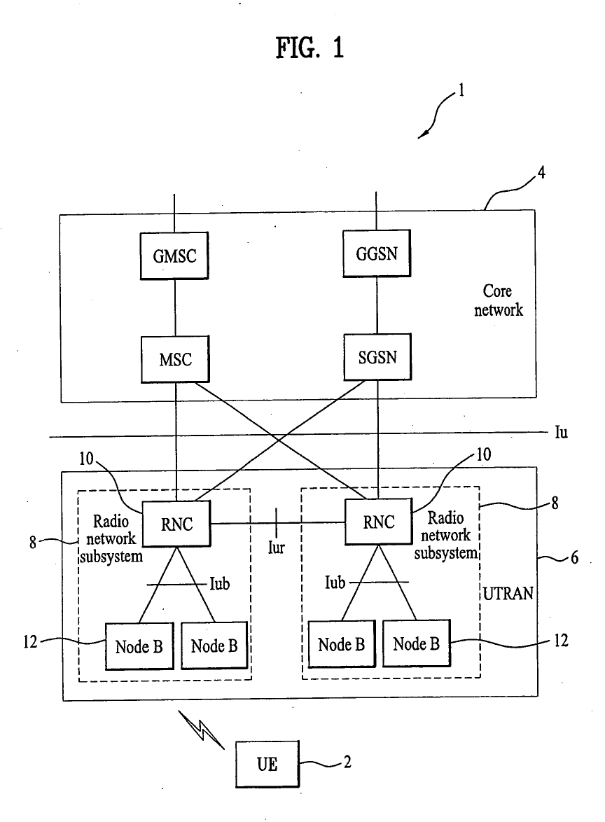

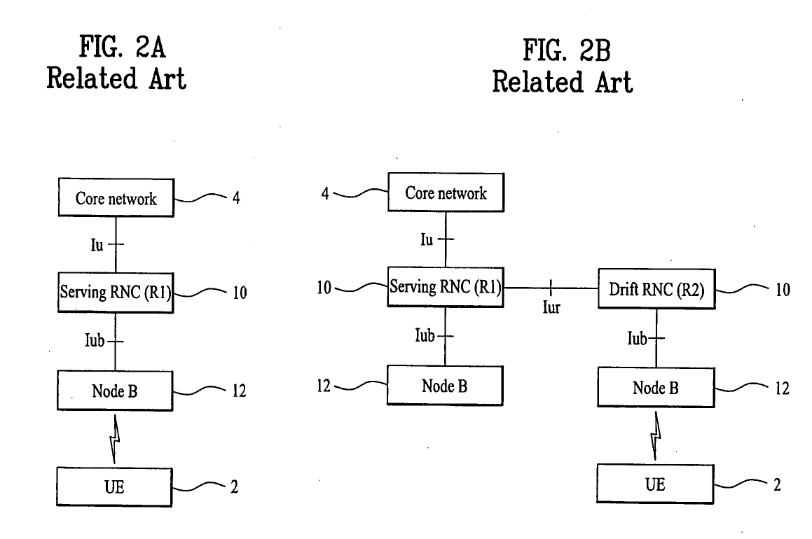

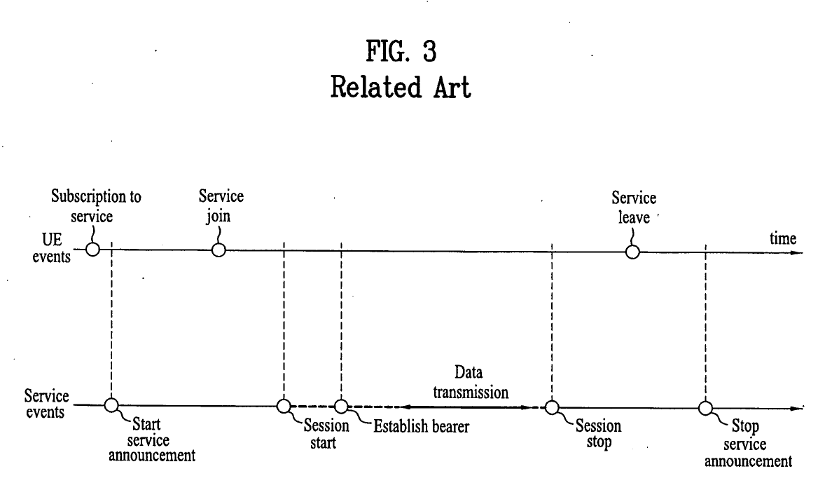

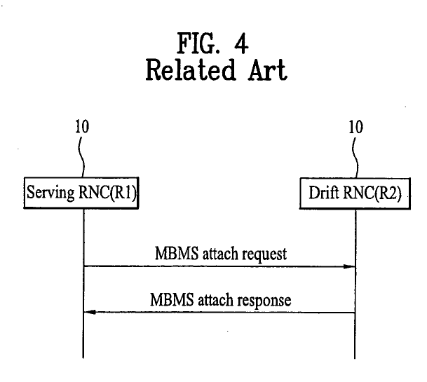

### DETAILED DESCRIPTION OF THE PREFERRED EMBODIMENTS

The present invention relates to a method and apparatus for providing a point-to-multipoint service to a mobile terminal that moves from an area controlled by one network controller to an area controlled by another network controller. Although the present invention is illustrated with respect to a mobile terminal, it is contemplated that the present invention may be utilized anytime it is desired to provide a point-to-multipoint service to a device that moves from an area controlled by a first controller to an area controlled by a second controller.

In the following description of the present invention, the transmission mode status of a specific point-to-multipoint service that a mobile terminal has joined is an indication of whether the radio bearer is a point-to-point radio bearer or a point-to-multipoint radio bearer. The transmission mode status information may be included in response to a point-to-multipoint service attach request made by a first controller to a second controller.

According to the present invention, a first network controller, for example a serving radio network radio controller (SRNC, R1) 10, receives a point-to-multipoint service attach response message associated with a point-to-multipoint service, for example a multimedia broadcast/multicast service (MBMS) attach response message associated with an MBMS. The MBMS attach response message is received from a second network controller, for example a drift radio network controller (DRNC, R2) 10. The serving RNC (R1) 10 utilizes the transmission mode status information included in the MBMS attach response message to determine whether to provide MDMS data to the drift RNC (R2).

If the transmission mode status information indicates a point-to-point radio bearer, the serving RNC (R1) 10 determines that MBMS transmission needs to be transferred to the drift RNC (R2). If the transmission mode status information indicates a point-to-multipoint radio bearer, the serving RNC (R1) 10 decides that transfer of the MBMS transmission to the drift RNC (R2) is unnecessary.

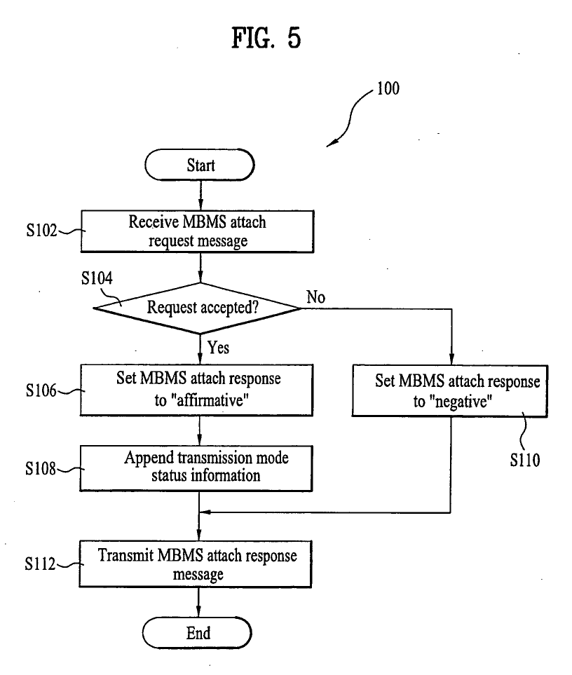

Referring to FIG. 5, a method 100 according to one embodiment of the present invention is illustrated. The method 100 is applicable to a drift RNC (R2) 10 and includes receiving an MBMS attach request message (S102), determining whether the requested service can be provided (S104), indicating either an affirmative response (S106) to the service request and appending an indication of the transmission mode status supported to an MBMS attach response message (S108) or indicating a negative response (S110) to the service request, and transmitting an MBMS attach response message to the serving RNC (R1) 10 (S112).

In step S102, the drift RNC (R2) 10 receives an MBMS attach request message from a serving RNC (R1) when a mobile terminal 2 moves from an area controlled by the serving RNC (R1) to an area controlled by the drift RNC (R2). The MBMS attach request message requests that a specific MBMS service be provided to the mobile terminal 2. In step S104, it is determined whether the MBMS service request is accepted, for example whether a radio resource for maintaining the RRC connection of the mobile terminal 2 can be allocated.

If the MBMS service request is accepted, the drift RNC (R2) 10 appends the mobile terminal's identifier (U-RNTI) to an RRC-connected mode mobile terminal list by setting an MBMS attach response message to “affirmative” in step S106 and appends transmission mode status information of the drift RNC (R2) to the MBMS attach response message in step S108. The RRC-connected mode mobile terminal list contains the identifiers of RRC-connected mode mobile terminals 2 for the specific MBMS being provided to joined mobile terminals in the new cell, for example the cell to which the mobile terminal has moved. The transmission mode status information is obtained by checking whether the radio bearer providing the MBMS to the mobile terminals 2 is point-to-point or point-to-multipoint.

If the MBMS service request is not accepted, the drift RNC (R2) 10 sets the MBMS attach response message to “negative” in step S110 and the drift RNC (R2) rejects the MBMS attach request of the mobile terminal. The U-RNTI identifier of the mobile terminal 2 is not appended to the RRC-connected mode mobile terminal list. The transmission mode status information may be omitted from the MBMS attach response message and an indication of the cause of the negative response may be included. Negative response cause information may inform the mobile terminal 2 that the MBMS can be received in the RRC idle mode, that the MBMS cannot be received in the RRC-connected mode, or simply that the drift RNC (R2) 10 was unable to allocate a resource to keep the mobile terminal in the RRC-connected mode.

An MBMS attach response message is transmitted to the serving RNC (R1) 10 in step S112. The MBMS attach response message contains either an affirmative response to the service request and the transmission mode status information or a negative response to the service request.

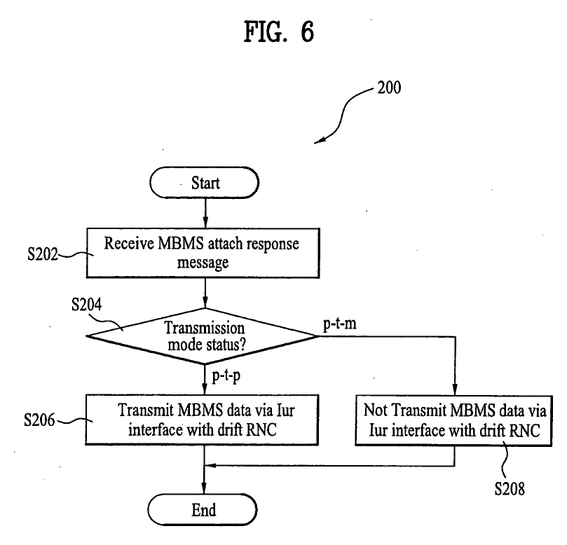

Referring to FIG. 6, a method 200 according to one embodiment of the present invention is illustrated. The method 200 is applicable to a serving RNC (R1) 10 and includes receiving an MBMS attach response message (S202) and, assuming an affirmative response to the service request, determining the transmission mode status of a drift RNC (R2) (S204) and either transmitting MBMS data to the drift RNC (R2) (S206) or not transmitting MBMS data to the drift RNC (R2) (S208).

In step S202, an MBMS attach response message is received from a drift RNC (R2) 10. The MBMS attach response message includes either an affirmative response to a service request and the transmission mode status supported by the drift RNC (R2) 10 or a negative response to the service request.

For purposes of illustrating the method of the present invention, it is assumed that the MBMS attach response message includes an affirmative response and the transmission mode status. In step S204, the transmission mode status indicated for the drift RNC (R2) 10 is determined.

If the transmission mode status of the drift RNC (R2) 10 is point-to-point (p-t-p), it is determined that the MBMS data must be transmitted to the drift RNC (R2) via an lur interface. In step S206, the MBMS data is transmitted to the drift RNC (R2) 10 via the lur interface.

If the transmission mode status of the drift RNC (R2) 10 is point-to-multipoint (p-t-m), it is determined that transmission of the MBMS data via the lur interface is unnecessary. In step S208, the MBMS data is not transferred to the drift RNC (R2) 10.

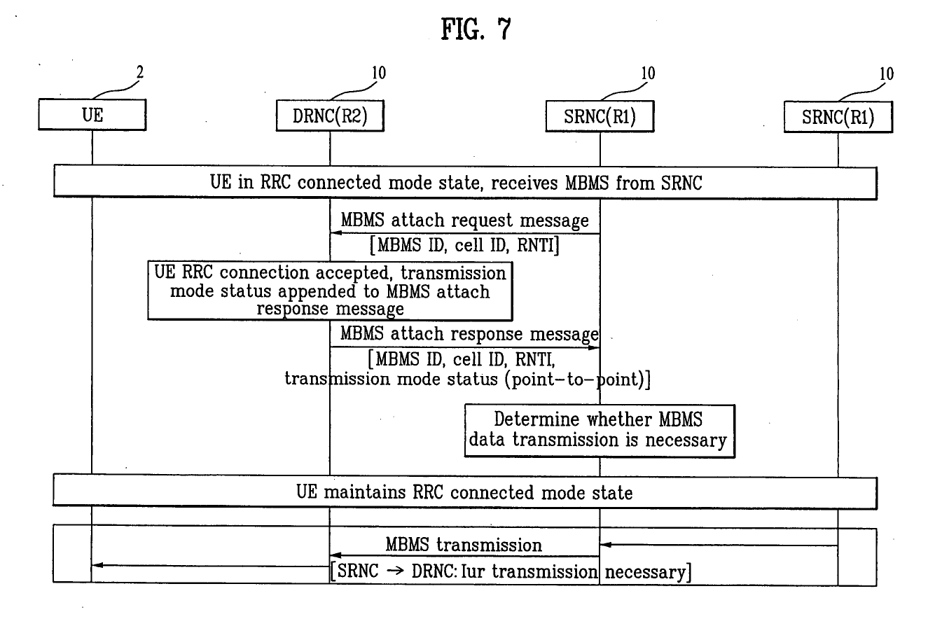

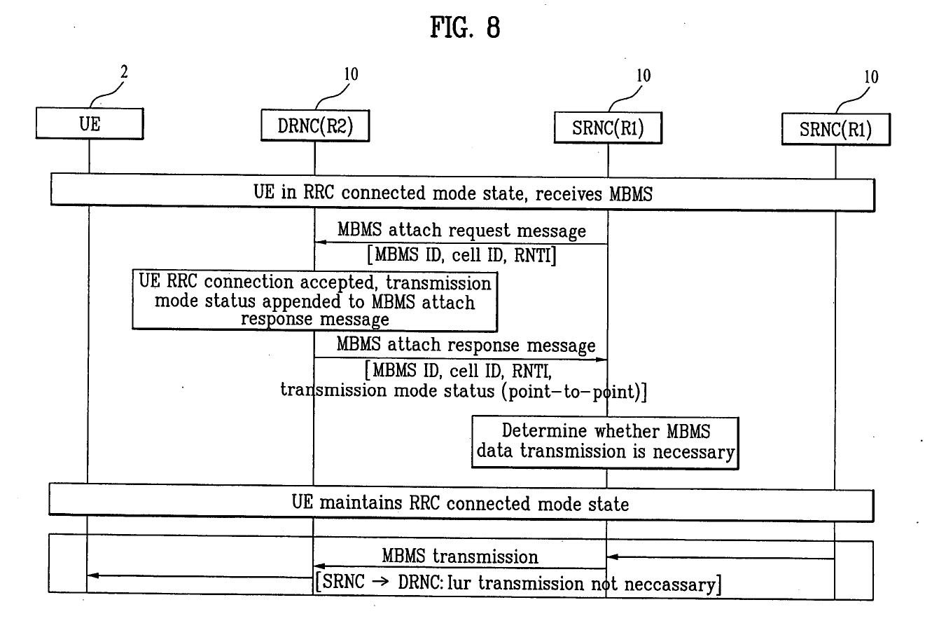

FIGS. 7 and 8 illustrate the two possible scenarios of FIG. 6. As illustrated in FIGS. 7 and 8, it is assumed that a mobile terminal 2, or user equipment (UE) in the RRC-connected mode has moved from a cell controlled by a serving RNC (R1) 10 to a cell controlled by a drift RNC (R2) and that the resource for maintaining the RRC connection is available in the drift RNC (R2) such that the drift RNC (R2) accepts the MBMS attach request from the serving RNC (R1).

The mobile terminal is receiving a specific MBMS via a point-to-point or point-to-multipoint radio bearer while maintaining its RRC-connected mode via the serving RNC (R1) 10. When the UE 2 moves to the new cell, the serving RNC (R1) 10 transmits an MBMS attach request message to the drift RNC (R2). The MBMS attach request message includes the MBMS ID of the specific service, the cell ID of the serving RNC (R1) 10, and the U-RNTI information of the UE 2.

The drift RNC (R2) 10 receives the MBMS attach request message and transmits an MBMS attach response message including transmission mode status information in addition to the MBMS ID of the specific service, the cell ID of the drift RNC (R2), and the U-RNTI information of the mobile terminal 2. The transmission mode status indicates whether the resource to be allocated in the drift RNC (R2) 10 is a point-to-point radio bearer or a point-to-multipoint radio bearer. The serving RNC (R1) 10 receives the MBMS attach response message from the drift RNC (R2) and utilizes the transmission mode status to determine whether to transmit the MBMS data to the drift RNC (R2).

As illustrated in FIG. 7, the transmission mode status of the drift RNC (R2) 10 is point-to-point and the serving RNC (R1) determines that MBMS data transmission to the drift RNC (R2) via the lur interface is necessary. The serving RNC (R1) 10 transmits the MBMS data to the drift RNC (R2) via the lur interface and the UE 2 is provided with the MBMS via the point-to-point radio bearer of the drift RNC (R2).

As illustrated in FIG. 8, the transmission mode status of the drift RNC (R2) 10 is point-to-multipoint and the serving RNC (R1) determines transmission of the MBMS data to the drift RNC (R2) via the lur interface is unnecessary. The serving RNC (R1) 10 does not transmit the MBMS data to the drift RNC (R2) via the lur interface and the UE 2 is provided with the MBMS via the point-to-multipoint radio bearer of the drift RNC (R2).

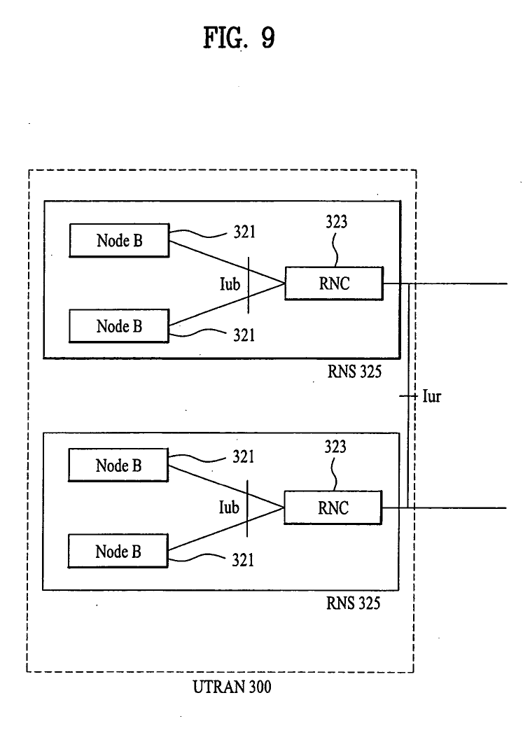

FIG. 9 illustrates a block diagram of a UTRAN 300 according to one embodiment of the present invention. The UTRAN 300 includes one or more radio network sub-systems (RNS) 325. Each RNS 325 includes a radio network controller (RNC) 323 and a plurality of Node-Bs (base stations) 321 controlled by the RNC. The RNC 323 handles the assignment and management of radio resources and operates as an access point with respect to a core network 4. Furthermore, the RNC 323 is adapted to perform the methods of the present invention.

The Node-Bs 321 receive information sent by the physical layer of a mobile terminal 2 through an uplink, and transmit data to the mobile terminal through a downlink. The Node-Bs 321 operate as access points, or as a transmitter and receiver, of the UTRAN 300 for the mobile terminal 2.

As described above, according to the method of the present invention, a drift RNC transmits to the serving RNC an MBMS attach response message including MBMS radio bearer information enabling the serving RNC to recognize the service transmission status of the cell to which a mobile terminal has moved, thereby allowing the serving RNC to determine if transmission of MBMS data to the drift RNC is necessary. Unnecessary data transmission between the serving RNC and the drift RNC is prevented and the efficiency of the radio resources between the drift RNC and the mobile terminal are enhanced.

It will be apparent to one skilled in the art that the preferred embodiments of the present invention can be readily implemented using, for example, a processor or other data or digital processing device, either alone or in combination with external support logic. It should be appreciated that the methods of the present invention may be implemented as a computer-readable program stored on such media as a CD-ROM, RAM, floppy disk, hard disk, or magneto-optical disk.

Although the present invention is described in the context of mobile communication, the present invention may also be used in any wireless communication systems using mobile devices, such as PDAs and laptop computers equipped with wireless communication capabilities. Moreover, the use of certain terms to describe the present invention should not limit the scope of the present invention to certain type of wireless communication system, such as UMTS. The present invention is also applicable to other wireless communication systems using different air interfaces and/or physical layers, for example, TDMA, CDMA, FDMA, WCDMA, etc.

The preferred embodiments may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Field Programmable Gate Array (FPGA), Application Specific Integrated Circuit (ASIC), etc.) or a computer readable medium (e.g., magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.).

Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the present invention, and that the article of manufacture may comprise any information bearing medium known in the art.

The logic implementation shown in the figures described specific operations as occurring in a particular order. In alternative implementations, certain of the logic operations may be performed in a different order, modified or removed and still implement preferred embodiments of the present invention. Moreover, steps may be added to the above described logic and still conform to implementations of the invention.

It will be apparent to those skilled in the art that various modifications and variations can be made in the present invention without departing from the spirit or scope of the invention. This, it is intended that the present invention cover such modifications and variations, provided they come within the scope of the appended claims and their equivalents.

1. A method of providing a point-to-multipoint service to a mobile terminal, the method comprising:
receiving, from a second network controller when the mobile terminal moves from a first cell controlled by a first network controller to a second cell controlled by the second network controller, information indicating one of a point-to-point and point-to-multipoint communication mode supported by the second network controller; and
determining whether to transmit point-to-multipoint service data from the first network controller to the second network controller according to the received information.

2. The method of claim 1, wherein the point-to-multipoint service is a multimedia broadcast/multicast service (MBMS).

3. The method of claim 1, wherein the information is received in a point-to-multipoint service attach response message.

4. The method of claim 1, further comprising not transmitting the point-to-multipoint service data to the second network controller when the information indicates a point-to-multipoint communication mode.

5. The method of claim 1, further comprising transmitting the point-to-multipoint service data to the second network controller when the information indicates a point-to-point communication mode.

6. The method of claim 1, wherein the first network controller is a serving network controller and the second network controller is a drift network controller.

7. A method of providing a point-to-multipoint service to a mobile terminal, the method comprising:
transmitting, to a first network controller when the mobile terminal moves from a first cell controlled by the first network controller to a second cell controlled by a second network controller, information indicating one of a point-to-point and point-to-multipoint communication mode supported by the second network controller;
receiving point-to-multipoint service data from a core network one of directly via the second network controller and via the first network controller and the second network controller; and
transmitting the point-to-multipoint service data to the mobile terminal.

8. The method of claim 7, wherein the point-to-multipoint service is a multimedia broadcast/multicast service (MBMS).

9. The method of claim 7, wherein the point-to-multipoint service data is received directly via the second network controller when the information indicates a point-to-multipoint communication mode.

10 The method of claim 7, wherein the point-to-multipoint service data is received via the first network controller and the second network controller when the information indicates a point-to-point communication mode.

11. The method of claim 7, wherein the information is transmitted in response to a point-to-multipoint service attach request message.

12. The method of claim 7, wherein the information is transmitted in a point-to-multipoint service attach response message.

13. The method of claim 7, wherein the first network controller is a serving network controller and the second network controller is a drift network controller.

14. A method of providing a multimedia point-to-multipoint service to a mobile terminal, the method comprising:
transmitting a point-to-multipoint service attach request message from a first network controller to a second network controller when the mobile terminal moves from a first cell controlled by the first network controller to a second cell controlled by the second network controller;
transmitting, from the second network controller to the first network controller, information indicating one of a point-to-point and point-to-multipoint communication mode supported by the second network controller;
receiving, in the second network controller, point-to-multipoint service data from a core network one of directly via the second network controller and via the first network controller and the second network controller; and
transmitting, from the second network controller to the mobile terminal, the point-to-multipoint service data.

15. The method of claim 14, wherein the point-to-multipoint service is a multimedia broadcast/multicast service (MBMS).

16. The method of claim 14, wherein the information is transmitted from the second network controller to the first network controller in a point-to-multipoint service attach response message.

17. The method of claim 14, wherein the point-to-multipoint service data is received in the second network controller directly via the second network controller when the information indicates a point-to-multipoint communication mode.

18 The method of claim 14, wherein the point-to-multipoint service data is received in the second network controller via the first network controller and the second network controller when the information indicates a point-to-point communication mode.

19. The method of claim 14, wherein the first network controller is a serving network controller and the second network controller is a drift network controller.

20. A radio network subsystem for providing a point-to-multipoint service to a mobile terminal, the radio network subsystem comprising:
a transmitter adapted to transmit point-to-multipoint service data to the mobile terminal and a second radio network subsystem;
a receiver adapted to receive information indicating one of a point-to-point and point-to-multipoint communication mode supported by the second radio network subsystem;
a storage unit adapted to store information related to the communication mode supported by the second radio network subsystem; and
a controller adapted to control the mobile terminal within a designated area and to process the information received from the second radio network subsystem in order to determine whether to transmit point-to-multipoint service data associated with the point-to-multipoint service to the second radio network subsystem when the mobile terminal moves from the designated area to an area controlled by the second radio network subsystem.

21. The radio network subsystem of claim 20, wherein the point-to-multipoint service is a multimedia broadcast/multicast service (MBMS).

22. The radio network subsystem of claim 20, wherein the receiver is further adapted to receive a point-to-multipoint service attach response message comprising the information from the second radio network subsystem.

23. The radio network subsystem of claim 20, wherein the controller is further adapted to not transmit the point-to-multipoint service data to the second radio network subsystem when the information indicates a point-to-multipoint communication mode.

24. The radio network subsystem of claim 20, wherein the controller is further adapted to transmit the point-to-multipoint service data to the second radio network subsystem when the information indicates a point-to-point communication mode.

25. The radio network subsystem of claim 20, wherein the controller is a serving network controller and the second radio network subsystem comprises a drift network controller.

26. A radio network subsystem for providing a point-to-multipoint service to a mobile terminal, the radio network subsystem comprising:
a transmitter adapted to transmit point-to-multipoint service data to the mobile terminal and information indicating one of a point-to-point and point-to-multipoint communication mode supported by the radio network subsystem to a second radio network subsystem;
a receiver adapted to receive point-to-multipoint service data one of directly from a core network and from the core network via the second radio network subsystem;
a storage unit adapted to store information related to the communication mode supported by the radio network subsystem; and
a controller adapted to control the mobile terminal within a designated area and to provide information indicating one of a point-to-point and point-to-multipoint communication mode supported when the mobile terminal moves from an area controlled by the second radio network subsystem to the designated area.

27. The radio network subsystem of claim 26, wherein the point-to-multipoint service is a multimedia broadcast/multicast service (MBMS).

28. The radio network subsystem of claim 26, wherein the point-to-multipoint service data is received directly from the core network when the information indicates a point-to-multipoint communication mode.

29 The radio network subsystem of claim 26, wherein the point-to-multipoint service data is received from the core network via the second radio network subsystem when the information indicates a point-to-point communication mode.

30. The radio network subsystem of claim 26, wherein the receiver is further adapted to receive a point-to-multipoint service attach request message from the second radio network subsystem and the controller is further adapted to provide the information in response to the point-to-multipoint service attach request message.

31. The radio network subsystem of claim 26, wherein the transmitter is further adapted to transmit a point-to-multipoint service attach response message to the second radio network subsystem and the controller is further adapted to provide the information in the point-to-multipoint service attach response message.

32. The radio network subsystem of claim 26, wherein the controller is a drift network controller and the second radio network subsystem comprises a serving network controller.
